(19) United States
(12) Patent Application Publication
(10) Pub. No.: US 2008/0152269 A1
(43) Pub. Date: Jun. 26, 2008

(54) Thermally stable bearings

(75) Inventor: Alex Habibvand, Orange, CA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/707,518

(22) Filed: Feb. 16, 2007

Related U.S. Application Data
(60) Provisional application No. 60/876,954, filed on Dec. 21, 2006.

(51) Int. Cl. F16C 32/06

(52) U.S. Cl. 384/100

(57) ABSTRACT

A rolling bearing has a first ring, a second ring concentric with the first ring, and a plurality of rolling elements disposed between the first and second rings, the first ring and the second ring both being generally annular and having gaps therein. A rotating mechanism has a support structure, a rotating structure, and a rolling bearing as described herein mounted on the support structure and engaging the rotating structure. A rotating mechanism having a CTE and a non-split ring bearing having a bearing CTE that is significantly less than the mechanism CTE can be improved by replacing the non-split ring bearing with a bearing having a similar CTE and a gap in the inner ring and in the outer ring.

### CROSS-REFERENCE TO RELATED APPLICATIONS

This application claims the benefit of U.S. provisional application No. 60/876,954, filed Dec. 21, 2006, the contents of which are incorporated herein by reference in their entirety.

### BACKGROUND

Rolling element bearings (“rolling bearings”) are well-known to comprise a plurality of rolling elements (balls, rollers, or the like) situated between two rings or races that are annular in configuration. For purposes of strength, economy and durability, bearings are often made from metal, e.g., steel.

Airborne systems commonly make use of large azimuth rolling bearings, e.g., bearings having an inner diameter of about 15.25 centimeters (cm) (6 inches (in.)) or more. The bearings are installed in rotating mechanisms (each of which comprises a rotating structure that rotates relative to a support structure) that have to be made from light aluminum alloys in order to control weight. Such bearings and rotating mechanisms can be found in airborne applications including electro-optical targeting system gimbals for camera mounts, search light gimbals, and elsewhere. Conventional bearings are installed and fitted in such mechanisms for optimum stiffness and rotational torque at ambient temperature, but the bearings exhibit significant variations in performance at extremes of temperature in actual use. At one temperature extreme, the bearing will be internally over-loaded to much higher stiffness and rolling friction torque than is optimal; yet at another extreme, the bearing internal preload may be compromised, resulting in loss of stiffness or excessive deflection. Such temperature-related variations in bearing performance are caused by differences in coefficient of thermal expansion (CTE) between the bearing materials (e.g., hardened steels) and the materials used for the rotating mechanism (e.g., aluminum alloys). These variations in bearing performance have to be carefully analyzed, and their consequences mitigated, often necessitating utilization of larger drive motors and/or using more expensive support structure alloys with CTE properties as close to bearing steel as possible.

### SUMMARY

A rolling bearing comprises a first ring, a second ring concentric with the first ring, and a plurality of rolling elements disposed between the first and second rings. The first ring is generally annular and has a first gap therein and the second ring is generally annular and has a second gap therein.

A rotating mechanism comprises a support structure, a rotating structure, and a rolling bearing as described herein mounted on the support structure and engaging the rotating structure.

A method is provided for improving a rotating mechanism having a CTE and a non-split ring bearing therein. The non-split ring bearing has a bearing CTE that is significantly less than the mechanism CTE, and the method comprises replacing the non-split ring bearing with a bearing having a CTE equivalent to that of the non-split ring bearing and a gap in the inner ring and in the outer ring.

### BRIEF DESCRIPTION OF THE DRAWINGS

FIG. 1 is a partial isometric view of one embodiment of a split ring bearing as described herein;

FIG. 2 is a partial elevation view of the bearing of FIG. 1;

FIG. 3 is a cross-sectional view of the bearing of FIG. 2, taken along line A-A; and

FIG. 4 is a schematic cross-sectional view of a rotating structure comprising a bearing as described herein.

### DETAILED DESCRIPTION

The rolling bearings described herein facilitate rotation in rotating mechanisms that are subject to wide working temperature variations, e.g., from 60° C. to −40° C., and wherein the CTE of the bearing is materially different from (e.g., smaller than) the CTE of the rotating mechanism in which it is used, and for large azimuth bearings. The difference in CTE between the bearing and the rotating mechanism may be, e.g., about 50% to about 100% of the bearing CTE. For example, the CTE of the support structure may be equal to or greater than about 150% of the CTE of the bearing rings, optionally up to about 200% of the CTE of the bearing rings. The bearings have a double split ring design in which both rings (the inner ring and the outer ring) are split, i.e., they each have a gap disposed radially across them. The gaps allow the rings to contract and flex as their temperature is lowered and in response to the physical force imposed by the rotating mechanism that may be contracting or expanding at a different rate from that of the bearing. The bearings exhibit reduced temperature-induced variations in bearing performance relative to non-split ring bearings.

In bearings having a double-split ring design, both rings of the bearing have gaps in them. Once properly installed in bearing support structure at room temperature, the bearings will maintain steady and predictable stiffness and torque characteristics throughout a wide temperature range, despite differences in CTE between the bearing and the support structure material. As a result, temperature-related variations in performance are greatly reduced, even if there is a significant difference between the CTE of the bearing material (e.g., steel) and the support structure material (e.g., aluminum). Thus, use of the bearings described herein results in improved rotating mechanism that comprise a support structure of a material having a different CTE from the bearing ring material, and in large azimuth bearings.

With knowledge of the CTE of the ring material, the width of the gap is chosen to approach zero at the lowest anticipated temperature and, if possible, to not exceed 50% of the ball diameter at the highest anticipated temperature. A gap having a width of about 0.76 millimeters (mm)(about 0.03 in.) to about 1.78 mm (about 0.07 in.) at room temperature will be suitable for many large azimuth bearings for airborne application.

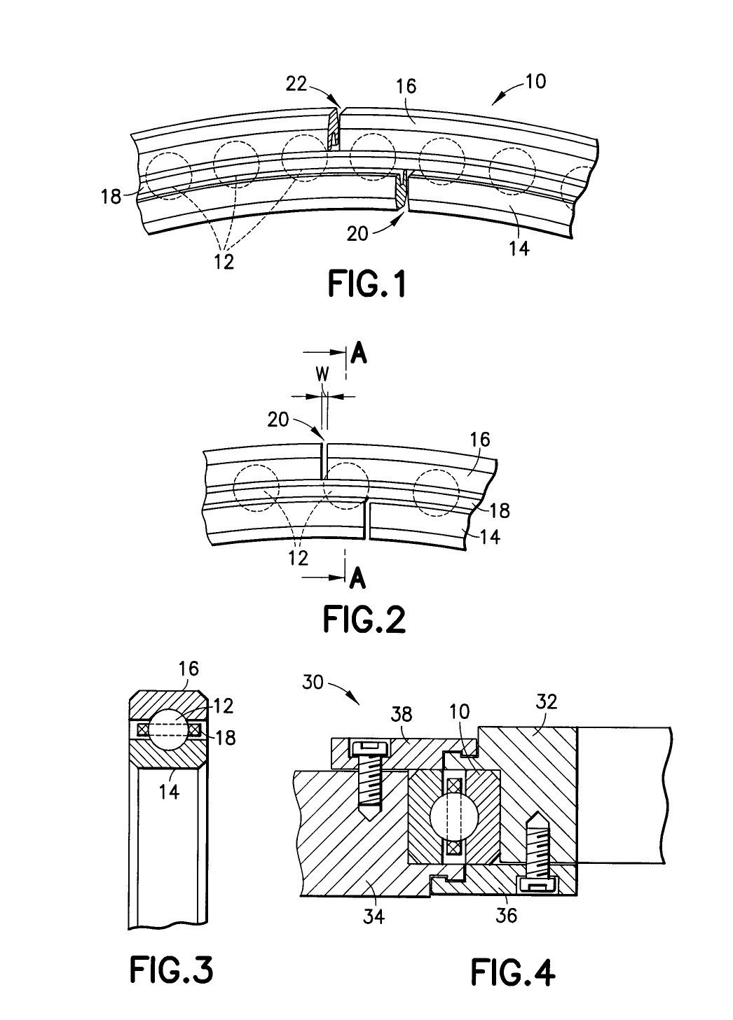

One illustrative embodiment of a double split-ring rolling bearing is shown in FIGS. 1, 2 and 3. Bearing 10 is a ball bearing comprising a plurality of rolling element balls 12 held in place between an inner ring 14 and a concentric outer ring 16 by a cage 18. Inner ring 14 is generally annual, except that it has a gap 20 where it is split. The gap 20 has a width W. Outer ring 16 is split at gap 22, which has a width similar to that of gap 20. In one illustrative embodiment, bearing 10 is made from 440 steel and comprises rings having diameters of about 790 mm (about 31 in.) and balls having a diameter of about 4.75 mm (about 3/16 in.), and has a gap of about 1.4 mm (0.05 in. to 0.06 in.) at room temperature. Thus, the gap is about 30% of the ball diameter.

A variety of rolling bearings can have split rings as described herein: ball bearings, roller bearings, needle bearings, thrust bearings, etc.

In FIG. 4, bearing 10 is shown in use in a rotating mechanism 30, which may be, for example, a search light gimbal. Mechanism 30 comprises a support structure 32 about which bearing 10 is situated, and a rotating structure 34 mounted on bearing 10. In particular, the inner ring of bearing 10 is secured to the support structure 32, while the outer ring of bearing 10 is secured to rotating structure 34. A first clamp 36 is secured to support structure 32 and engages rotating structure 34 in an annular tabled lap joint. Similarly, a second claim 38 secured to the rotating structure 34 engages the support structure 32 in an annular tabled lap joint. Bearing 10 and joints 36 and 38 facilitate the rotation of rotating structure 34 relative to support structure 32. Support structure 32 and, optionally, rotating structure 34, may be made from aluminum or known aluminum alloys having a CTE of about 13×10⁻⁶ in./in./° F. (about 2.3×10⁻⁵ in./in./° C.), whereas the rings of bearing 10 may be made from steel having a CTE of about 8.2×10⁻⁶ in./in./° F. (about 1.5×10⁻⁵ in./in./° C.). Thus, the rotating mechanism has a CTE that about 60% greater than the CTE of the bearing rings, i.e., the support structure CTE is equal to about 160% of the bearing ring CTE. The split ring structure of bearing 10 allows it to maintain good performance over a wide temperature range despite the difference in CTE between the bearing material and the support structure material.

Rotating mechanisms that comprise conventional, non-split ring roller bearings and in which there is a significant difference between the rotating mechanism CTE and the bearing ring CTE can be improved by replacing the non-split bearing with a bearing comprising gaps in the rings as described herein, even if the split ring bearing CTE is equivalent to that of the non-split ring bearing. A result will be a reduction in temperature-induced stress over the working temperature range of the mechanism even though the difference in CTE between the mechanism and the bearing therein is substantially unchanged.

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. Likewise, the terms “a” and “an” herein do not denote a limitation of quantity, but rather denote the presence of at least one of the referenced item. Characterizations of any feature in geometric terms (e.g., annular, circular, etc.) does not require precise adherence to geometric forms, but rather allows minor variations to accommodate reasonable manufacturing tolerances.

Although the invention has been described with reference to particular embodiments thereof, upon a reading and understanding of the foregoing disclosure, it will be understood by one of ordinary skill in the art that numerous variations and alterations to the disclosed embodiments will fall within the spirit and scope of this invention and of the appended claims.

What is claimed is:

1. A rolling bearing comprising:
a first ring;
a second ring concentric with the first ring; and
a plurality of rolling elements disposed between the first and second rings;
wherein the first ring is generally annular and has a first gap therein and the second ring is generally annular and has a second gap therein.

2. The bearing of claim 1, wherein bearing is a large azimuth bearing and the first gap is about 0.76 mm (about 0.03 in.) to about 1.78 mm (about 0.07 in.) wide at room temperature, and the second gap is about 0.76 mm (about 0.03 in.) to about 1.78 mm (about 0.07 in.) wide at room temperature.

3. A rotating mechanism comprising:
A support structure;
a rotating structure; and
a rolling bearing mounted on the support structure and engaging the rotating structure, the rolling bearing comprising a first ring, a second ring concentric with the first ring, and a plurality of rolling elements disposed between the first and second rings; and
wherein the first ring is generally annular and has a first gap therein and the second ring is generally annular and has a second gap therein.

4. The mechanism of claim 3, wherein the bearing rings have a CTE and the support structure has a CTE that is at least about 50% greater than the CTE of the bearing rings.

5. The mechanism of claim 3, wherein the bearing is made of steel and the support structure and the rotating structure comprise aluminum.

6. The mechanism of claim 3, wherein the bearing is a large azimuth bearing and the first gap is about 0.76 mm (about 0.03 in.) to about 1.78 mm (about 0.07 in.) wide at room temperature, and the second gap is about 0.76 mm (about 0.03 in.) to about 1.78 mm (about 0.07 in.) wide at room temperature.

7. A method for improving a rotating mechanism having a CTE and a non-split ring bearing having a bearing CTE that is significantly less than the mechanism CTE comprises replacing the non-split ring bearing with a bearing having a CTE equivalent to that of the non-split ring bearing and a gap in the inner ring and in the outer ring.
